(19) United States
(12) Patent Application Publication
(10) Pub. No.: US 2003/0149742 A1
(43) Pub. Date: Aug. 7, 2003

(54) Method and system for staging content

(76) Inventor: Chris Bollerud, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/068,967

(22) Filed: Feb. 6, 2002

(51) Int. Cl. G06F 15/16

(52) U.S. Cl. 709/217; 709/232

(57) ABSTRACT

A host server is disclosed that includes a content staging system. The content staging system enables the content providers to localize and verify the accuracy and error-free status of their content so that it may be made available to clients desiring the content while minimizing or preventing any errors before posting on the Internet. In order for these content providers to be able to publish their data to the website, they must first copy their data and attributes to the staging system. This staging system processes the data in a timely manner and makes it available to the content provider who submitted it in a first-in, first-out queue.

### BACKGROUND OF THE INVENTION

1. Technical Field

The present invention relates generally to managing content to be accessed by an end user by a presentation system within a content providing environment. More particularly, the present invention relates to a content staging system and method to analyze, filter and modify content managed by a host server as received from different sources.

2. Related Art

The Internet is an information management system that lacks a central location for repositing all information and data. Thus, the transfer of information is not centrally managed. Since the Internet does not have a central location for retaining information, it is dependent upon various networks and host computers to perform such a function. The Internet is a patchwork of other networks and host computers and because of such, it has developed a myriad of formats to present information, store it, and then subsequently access it over the Internet. Typically, the content is stored at a server or host level and then accessed by various clients requesting the information.

Not all content submitted for access is provided in formats that are compatible with the host server. Further, when the format may be compatible with formats not supported by the host server, the host server may desire to standardize on selected formats prepared expressly for that host server or for other advantages such as access speed, system security, or content stability. As such, the system must make a format conversion of the provided content, whether it was originally in a compatible format, so that it will either run or run optimally on the host server. The format conversion process has been greatly automated, but some problems still exist. For example, the conversion fails to take into account errors that exist in the content or relationships to other content, such as address or link errors, and ferreting out such errors and fixing them is both labor intensive and time-consuming.

Additionally, information that once was accessible or intended to be accessible in the future can result in stale information or broken links. The broken links result in error messages stating either the information cannot be found or that the link is in error. The failure to locate the information due to the broken link errors frustrates the end user seeking the information, which results in dissatisfied customers.

Prior solutions for fixing broken links and updating information have been time consuming, as they have required manual review and correction. Typically, someone, such as the web designer or content developer, must manually check each link by accessing the website and verifying that the information is available. The developer is left to rely on e-mails sent by frustrated clients and consumers looking for the missing links in order to learn a problem even exists. Having consumers notify the web host that the link is down results in other problems such as bad public relations and unreliability.

Once the web designer or content provider manually updates or fixes the access problem to the information manually, the content can then be made accessible to the end users. Unfortunately, many end users become frustrated with broken links and stale data and do not bother to inform the host of the errors and move on to other sources that provide them the content they seek. Thus, it is a commercial disadvantage to have broken links and stale data at consumer sites available on the Internet. Further, it is time consuming and expensive to have one or more individuals constantly monitor the success and accuracy of the links and content to prevent broken links, stale data, or erroneous addresses from reaching the end user.

Accordingly, what is needed is a method and apparatus that can detect and prevent corrupt or broken links from being posted within a host server on the Internet. Also, what is needed is a method and apparatus to notify a content provider when such errors occur and to prevent them from being posted so that the content provider can correct the errors before they are made available online. Furthermore, what is needed is a method and apparatus for streamlining the conversion of various types of Internet content in manners that are consistent with the host system's standard formats for purposes of simplifying the process of providing content on the server and for providing uniform content in formats that are easily managed by the host system.

### SUMMARY OF THE INVENTION

According to the present invention, a host server is disclosed that includes a content staging system. The content staging system enables the content providers to localize and verify the accuracy and error-free status of their content so that it may be made available to clients desiring the content while minimizing or preventing any errors before posting on the Internet.

### BRIEF DESCRIPTION OF THE DRAWINGS

FIG. 1 illustrates an embodiment of a host system that has assorted content providers and end users in accordance with the present invention.

FIG. 2 illustrates an embodiment of a content staging system implemented in the host server of FIG. 1 in accordance with the present invention.

FIG. 3 illustrates a flow diagram of the method embodiment utilized by the content staging system of FIG. 2 in accordance with the present invention.

### DETAILED DESCRIPTION OF SPECIFIC EMBODIMENTS

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

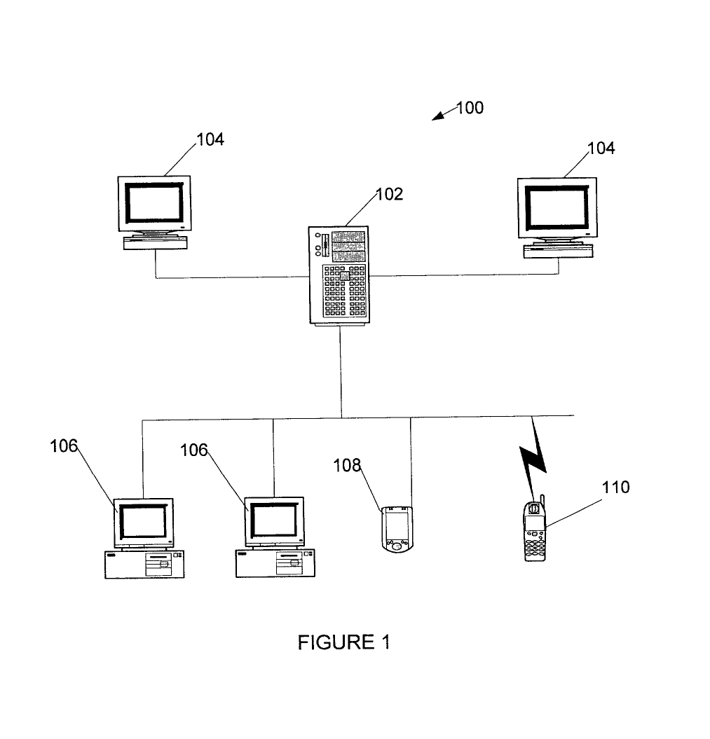

FIG. 1 illustrates a host system 100 that operates within an Internet environment. Such systems are well known to those skilled in the art and typically comprise a server-type computer system with a storage system and high-speed Internet connection. The host system 100 operates as a host server to provide access to content over the Internet. Typically, web users access the content provided by the host system 100. The host system 100 includes a host server 102 that is further networked to various content provider systems 104. Provider systems 104 are operated by content developers and are used to develop and provide the content that will be accessible on the host server 102. The clients that access the content offered on the host server 102 typically do so via the Internet using one or more types of presentation systems such as desktop systems 106, a personal digital assistant 108, laptop systems (not shown), or wireless transmission devices such as a cell phone 110.

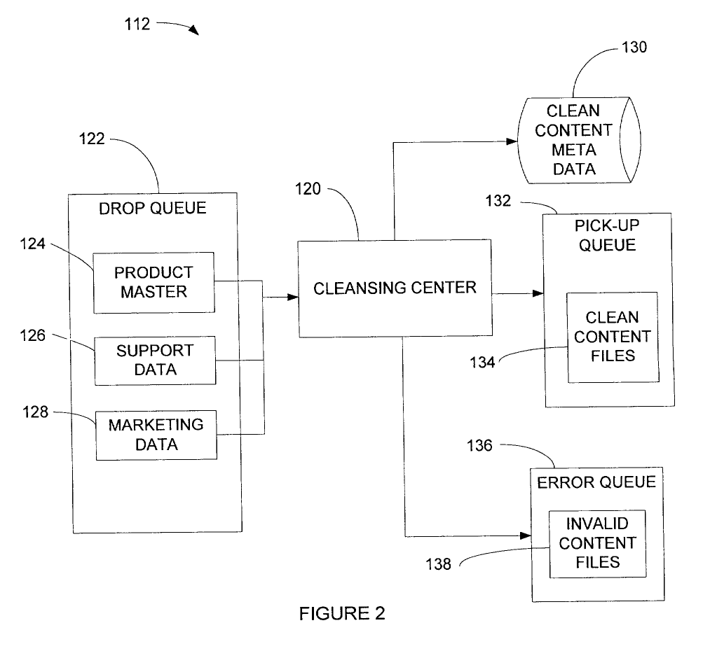

The host server 102 further includes a content staging unit or system 112, which is shown in greater detail in the diagram of FIG. 2. Content staging system 112 includes an operating signal which performs data cleansing on submitted content by analyzing, filtering and modifying content from the various content providers 104, which deliver their content to the Drop Queue 122. A sample configuration file utilized by content staging system is found in Appendix A. As content is sent to content staging system 112, it is cleansed and cross-referenced to ensure that the content is consistent and usable. If the content does not pass system validation, it is rejected and moved to the Error Queue along with a message as to why the content was rejected. The content provider who provided the content is notified of the rejection so that the provider can correct the content and resubmit it for validation. Software applications that source their content from the staging system 112 are then assured that a high degree of consistency within the data is achieved. Content providers may deliver their content from an automated system, such as a commercially available system like Documention® provided by Documentum, or manually using a provided XML format.

Typically, content providers utilize their websites as a resource for consumers, which may be directed to individual users, small, medium, or large businesses, or any combination thereof. The sites are typically created to provide an awareness of the providers' products, services, and solutions, as well as to provide basic support. When a client or customer selects a given page provided by the content provider, the page or content typically comes from a variety of sources. The host server typically forwards the content as cache copy on a local server in order to improve performance, but the source of the content typically remains in the originating database or databases. Thus, content providers are responsible for making sure that all content is up-to-date, accurate, and localized as required.

The content staging system enables the content providers to localize and verify the accuracy and error-free status of their content so that it may be made available to clients desiring the content while minimizing or preventing any errors before posting on the Internet. In order for these content providers to be able to publish their data to the website, they must first copy their data and attributes to the staging system. This staging system processes the data in a timely manner and makes it available to the content provider who submitted it in a first-in, first-out queue. Alternatively, the content may be processed according to a priority hierarchy for the submitted content as established in the staging system. For example, in the case of an emergency edit, the content provider may expedite processing of the data by either expiring any prior data within the staging system or by using the same unique identifier of the content to be replaced with the new content actually replacing the old content. This allows the system to override the currently published data and then allow the content managing architecture to publish the data. This allows these updates to appear to the end users or clients as soon as possible. Further, the system may also delete or expire content automatically based on the hierarchy of when the content is considered to be valid versus being stale. If the content is expired, then a secondary path for other data will be provided in order to provide the content user with useful information regarding the page selected.

Each document referenced on the site includes sufficient metadata within a HTML to allow the document source to be quickly found. This enables the content provider the ability to change the source document quickly should an error be found on the website. Once the document is corrected, the content provider can resubmit the document to the staging system, where it will wait to be published.

The metadata, as recognized by the system through the earlier registration step, includes data defining the particular region and language attributes of a given content file and will properly display the appropriate version. If a localized version does not exist, then an international version can be utilized. This allows localized documents to be created “on-the-fly” at the source and to be published at the next publishing cycle.

If the system receives several versions of software or information available about a given product being supported, then all these versions will be published by the content staging system. This is provided because several versions may be required to support a given product. For example, certain new versions of software may not be compatible with a particular hardware configuration, so additional content is needed to service the hardware content. In these situations, the source content provider is responsible for removing material that is out of date.

As new languages and products are added or subtracted from the server host site, the server host site will be dynamically adjusted.

The content staging system 112 further includes a cleansing center 120, a drop queue 122, which is coupled to the cleansing center 120, a clean content metadata storage unit 130, a pickup queue 132, and an error queue 136. The clean content metadata storage unit 130, the pickup queue 132, and the error queue 136 define a content pickup zone. The source content providers place their content in the drop zone or drop queue 122 where the cleansing system 120 analyzes and cleans the content, and then moves it to the pickup zone either in the pickup queue 132 or in the error queue 136.

According to one specific embodiment of the present invention, drop queue 122 is a NetBIOS share and file transfer protocol (FTP) site that is organized into a directory structure. One example of a drop zone for sample data is:

• FTP

∘ ftp://contentstagingsystem.smithco.com/SMBDropZone/

• Net Bios Share Name

∘ \\ContentStagingSystem\DropZone

Within the drop zone is a hierarchical structure of folders named according to the content types that are being delivered. This allows multiple content providers to deliver to the same system without worry about file naming conventions. It also allows separate pieces of content to be processed by customized filters that may be required. Each content type is limited to a single directory within the structure. Three examples of different content types are illustrated. The first content type is called product master 124. The second content type is support data 126, and the third content type is marketing data 128. The directories may be of any type directory associated with a particular type of content to be stored. For example, the support data directory 126 holds support data while the marketing data directory 128 holds marketing data. Other types of directories are also possible.

The content providers are able to drop or deliver content to drop queue 122 at any time. Before the content can be dropped within the drop queue 122, each content provider must register with the system to set up the new content type and to provide basic information about the content provider as well as other parameters necessary for identifying and rectifying content. The submission typically includes one description file as a minimum and one or more optional content or data files. The description file at times is sufficient to provide a self-contained piece of content.

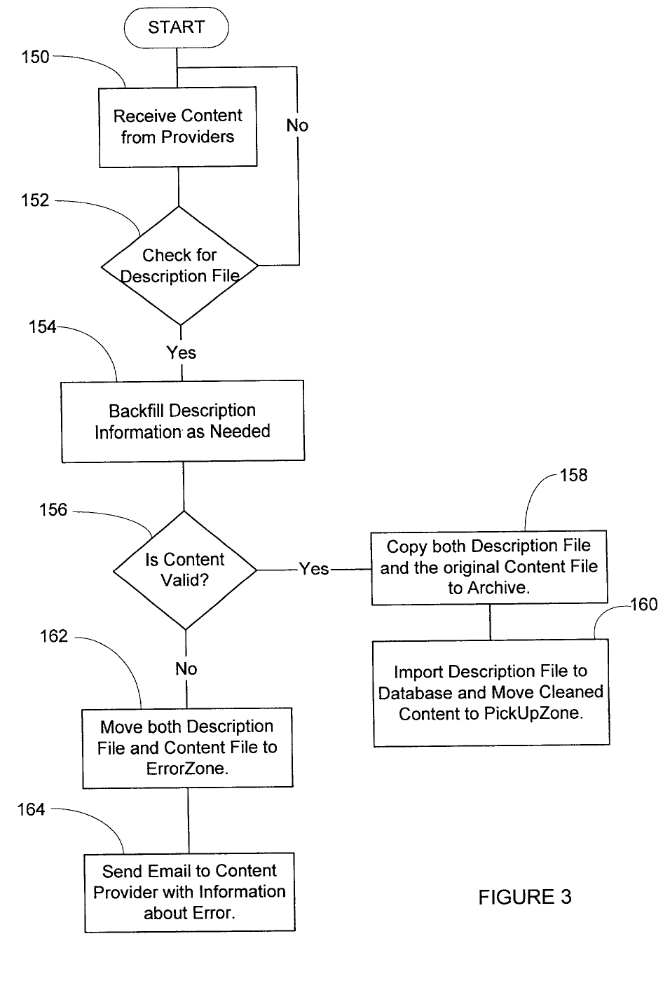

FIG. 3 illustrates a flow diagram of the method of implementation as performed automatically by content stage system 112 of FIG. 2. After the content provider has registered with the host server through the content staging system 112, the content provider can then drop off content in drop queue 122, as shown in Block 150. The content consists of a data file, such as an HTML, DOC or PDF document, and the description file, which are also considered to be elements. The description file can be a standard XML as defined by the Staging system DTD. One exemplary embodiment of the DTD is found in Appendix B. There is also the option to create a customized filter for the cleansing center to handle proprietary file formats. In one embodiment, the invention utilizes customized filters for InfoWorks exports, Mind Map output and several text file formats. The customized filter typically converts the file into a data structure that matches the Staging system DTD. In many cases there are portions of content that do not meet all the requirements for a successful submission. To accommodate this situation the content type registration process allows the creation of default values that will be substituted.

Cleansing center 120 performs the bulk of the operation of the content staging system. Cleansing center 120 continuously searches drop queue 122 for new content to be processed. Once the cleansing center 120 has processed the new content, it places it within the pickup zone in either the pickup queue 132 or the error queue 136. A copy of the most recent submissions of content is maintained within an archive, which allows the content providers to review what was placed within the drop queue 122. Once the content is processed, it is removed from the drop queue 122.

If a subsequent copy of the same content is submitted, the second copy is utilized as an update of the original content. If the second copy is not valid, the original content will be preserved until it is invalid or replaced. Data that was once valid becomes invalid if it expires or is replaced by a newer copy. The staging system 112 reviews the content looking for the source system object identifier (objectID or OID) to determine whether the content is an update, add or expire. The objectID is considered unique within a single content provider's source database. This allows multiple content providers to use the same numbering system without replacing each other's content. If the content is an update, the copy is then updated to the current system. If the content is an add, the staging system adds the new content accordingly. If the content is expired, then the content is no longer valid and the staging system removes the content from active accessibility by the end users.

At a high level, there are two types of content that are typically submitted to the drop queue 122. The first content type is a hierarchy of information and the second content type is a document. All documents may be related to any branch on the hierarchy. This allows the system to build navigation trees to documents and to readily change either the navigation tree or any leaf document by resubmitting new content.

Cleansing center 120 selects the content to be processed and determines whether the metadata within the content is consistent with the format registered by the content provider. The metadata is located within the description file. Thus, the system, as shown in block 152, checks for the description file, which includes the metadata. The metadata allows the system to locate or identify the document source, i.e. the content provider. This further allows the cleansing center 120 to notify the content provider that the content has either passed validation and is ready for pick up and subsequent posting on the Internet or that an error(s) exists, which prevents it being validated but the notice allows the content provider to fix the error for resubmission.

In order for the content staging system to operate properly, all data that is inserted into the content staging database must contain at least one description file. The cleansing center 120 is then able to read the description file using the appropriate filter as defined by the staging system configuration. For example, a text file will require a customized filter to read the text. XML files that conform to the staging system DTD can use the generic XML import filter. All content is internally converted to a common format where it is cross checked against control tables and existing hierarchical data. Control tables are variable lookup tables such as a list of ISO country codes, a list of MIME types, etc. While a filter may standardize a value (I.e. convert “United States” to the ISO Country Code “us”) the validation process confirms that converted value is included in the proper control table.

The filter's responsibilities include backfilling any missing information and converting unknown formats to a common format as shown in block 154. Each content type can be delivered from differing sources that have unique data needs. Sometimes the needs of the source provider do not include all the data that would be needed for an application that would pull content from the staging system. In order to accommodate this need, content types can be registered with a default set of data. The customized filter is then capable of backfilling this data for the content as it is imported. The filter also is able to convert individual data within a content item to a common format. Common conversions may be date formats or country names to country codes. A special example of this is the ability to guess the MIME type of a static file by the extension that is used by the file. For instance if a description file describes a static file, but does not contain a MIME type, the filter can read the extension and infer the proper value.

Cleansing center 120 further stages all active content files. The most recent versions of any data submitted by the content providers reside in this area. The cleansing center 120 can then enable multiple sources to populate their databases with this particular information. The data stored here consists of one data file and one XML description file, or it may include one XML description file with the field for the file name left blank.

Next, as shown in block 156, the cleansing center determines whether the content is valid. If the content is valid, the system then proceeds to block 158; otherwise, the system proceeds to block 162. In block 158, the system copies both the description and the original content file to the archive as has been previously described.

In block 160, the system imports the description file to the particular database and moves the clean content to the pickup zone such as to pickup queue 132 where it is stored within a clean content file 134. Meanwhile, the metadata from the clean content is stored in the archive 130. If the cleansing center 120 determines that the content is invalid, the cleansing center 120, as shown in block 162, moves the description file and content file to the error queue 136, where it is stored. At this time, the cleansing center 120 notifies the content provider, i.e. via e-mail as shown in block 164, of the error. This error notice identifies an error has occurred and what the error is. The content provider can use this error information to fix the error and resubmit the document for validation.

A special case of content items includes complex documents. These are documents that are not capable of being represented by a single description file and/or a single static file. In this case the content provider has two options depending on the requirement of the content. The first is to submit a series of description files that all contain the same group attribute signaling that they will work together. If order is important, it is possible to sequence the items as necessary. The second type of complex content is an HTML page that includes local links to additional content. In this case the content provider only needs to create a description file to the master file. The staging system will create internal content items for each of the linked items. As part of the cleansing process it also ensures that there are files supplied for every link within the HTML and adjusts the paths to match the pickup zone requirements. Should the HTML be found to be invalid the content is rejected.

When displaying a page, the website must be able to determine which piece of content to show. A set of key values, also known as metadata, is provided to select the content from the database. These key values include content type, country, and language. Other types of key values may also be selected or defined according to the needs of the webmaster. In addition to these three values, the site has the ability to use relationships as additional key values.

A relation is a single relationship between a piece of content and one of a group of relation types defined. An example is shown as follows:

ContentType: OfficeBluePrint

Country: US

Language: EN

Relationships:

Relation

RelationType: Product Type

RelationName: Printers

Relation

RelationType: Support Task

RelationName: solve a problem

A RelationType is the category for which the content provider is trying to make a relation for the data to be shown. Some examples of possible RelationType values include support task, content group, product line, product class, product type, product type OID, etc. The manager of the content staging system may define these types.

The content staging system was developed with content driven website development in mind. Prior art solutions have been difficult to use, slow, and require significant human interaction. Embodiments of the invention work with multiple content formats that more closely resemble the source content and then molds the multiple content formats into a single format. It also offers relationship data cleansing to ensure that documents and hierarchies are reliably linked. Thus, some of the benefits of the content staging system are that it allows for (i) content to be submitted in source of format at any time, (ii) clean and consistent content can be retrieved at any time, and (iii) content expiration remains persistent until modified content is submitted.

Data Type Dictionary (DTD)

The following is a description for each of the elements in the Content DTD in accordance with one embodiment of the present invention. Each element is disclosed, with an example of how it is implemented along with a description of such implementation. An Element is part of the XML language used to define data types that are allowed to be used. The ELEMENT tag is used within a DTD to make these declarations. An element may be defined as a group of one or more subelements/subgroups, character data, EMPTY, or ANY. altTag

<!ELEMENT altTag (#PCDATA)>

If the submitted content is an image, then this will be the altTag that is shown during a mouseover.

availableAtStore

<!ELEMENT availableAtStore (#PCDATA)>

This is a sub type of priceInformation. Its values can be “yes” or “no” to indicate that the product is available to be purchased at an online store. This value will be used to determine whether to show the “Buy Now” button on the site.

branch

<!ELEMENT branch (branchName, branchType?, branchOID?, branchDescription?, url?, branch*)>

branch is a sub type of hierarchy or branch. It is used to create a tree hierarchy that is used to generate a menu system. See below for the descriptions of each of it's sub types.

branchDescription

<!ELEMENT description (#PCDATA)>

This optional item is the description of the branch. It will be displayed below the branchName on the site if it is supplied.

branchName

<!ELEMENT branchName (#PCDATA)>

If a hierarchy is submitted then branchName is required for every branch.

branchOID

<!ELEMENT branchOID (#PCDATA)>

This optional element is used to link to product OID's in particular cases.

branchType

<!ELEMENT branchType (#PCDATA)>

This required element is used to identify the type of branch when required to differentiate branch levels. This value must be a valid RelationType.

cascade

<!ELEMENT cascade (#PCDATA)>

This element determines whether the submitted content is related only to the item in relationName (value of “no”) or whether it is related to the item in relationName and all its children (value of “yes”).

contact

<!ELEMENT contact (contactName, contactphone, contactEmail)>

This is a required element that must contain three elements. It cannot contain any text. The three elements must be placed in order: contactName, contactPhone, contactEmail.

contactEmail

<!ELEMENT contactEmail (#PCDATA)>

This required element is the email address of the content contact.

contactName

<!ELEMENT contactName (#PCDATA)>

This required element is the name of the content contact.

contactPhone

<!ELEMENT contactPhone (#PCDATA)>

This required element is the phone number of the content contact.

content

<!ELEMENT content (contentType, contact, sourceDatabase, languages, (regions|countries), publishDate?, expireDate?, contentItems, publishImmediately?)>

This is the main element of any XML submitted. There can be one and only one content section.

contentItems

<!ELEMENT contentItems (item+)>

This required element is a container for submitted items. It must exist and it must contain at least one item.

contentType

<!ELEMENT contentType (#PCDATA)>

This required element is the name of the content type submitted. If an invalid or misspelled content type is submitted, it will be rejected by the parser and not the DTD.

componentName

<!ELEMENT componentName (#PCDATA)>

This element is a required sub type of the optional components tag. It can be used to provide clarity about where on the site to display the submitted content.

components

<!ELEMENT components (componentName+)>

The optional element is used to create a list of components where to display a piece of content. It is only needed in cases where there can be confusion about where content should appear on the site.

countries

<!ELEMENT countries (ISOCountryCode+)>

This is a required list of ISO Country Codes. It can only contain 1 or more of the element ISOCountryCode. See ISOCountryCode for more information.

createdDate

<!ELEMENT createdDate (#PCDATA)>

This optional element is the date the content was first created.

Must be one of the following formats:

d/m/yy (example 5/23/01)

d/m/yyyy (example 5/23/2001)

d MM yyyy (example 23 May 2001)

expireDate

<!ELEMENT expireDate (#PCDATA)>

This optional element determines when to remove content from the site. If the submitted expireDate is today or in the past it will trigger the content to be removed at the next publishing cycle.

Must be one of the following formats:

d/m/yy (example 5/23/01)

d/m/yyyy (example 5/23/2001)

d MM yyyy (example 23 May 2001)

filePath

<!ELEMENT filePath (#PCDATA)>

This optional element is a pointer to a submitted item. For instance, if a image is submitted then the relative path and filename should be given here. If the XML is the only content then this element should not exist.

hierarchy

<!ELEMENT hierarchy (branch+)>

This optional element is used to create a tree hierarchy. It is used to submit menu systems. If this element is used then it must contain at least one branch.

ISOCountryCode

<!ELEMENT ISOCountryCode (#PCDATA)>

This is an ISO 3166 country code. Sample codes include:

GB—United Kingdom

US—United States

AU—Australia

ISOLanguageCode

<!ELEMENT ISOLanguageCode (#PCDATA)>

This is an ISO 639 language code.

item

<!ELEMENT item (objectID, title?, filePath?, mimeType?, createdDate?, modifiedDate?, keywords?, summary?, (relationships|hierarchy)?, group?, ranking?, components?, url?, altTag?)>

This required element is the container for information about the content submitted. Multiple items can be submitted within the same file as long as they share the same country and language attributes.

keyword

<!ELEMENT keyword (#PCDATA)>

If the keywords element is used then this is a required subelement of keywords. It is used to tag content with a keyword if so required.

keywords

<!ELEMENT keywords (keyword+)>

This optional element is a container for multiple keyword values.

localizedLanguage

<!ELEMENT localizedLanguage (ISOLanguageCode, ISOCountryCode)>

This required element is a container for multiple language values. It should contain one ISOLanguageCode and one ISO CountryCode which represent the language and country localization of the text within the submitted document.

mimeType

<!ELEMENT mimeType (#PCDATA)>

This optional element is used to identify the type of file named in filePath. It should be used for every file that is submitted. The values should conform to the IANA mime type classification. (I.e. text/html or image/jpeg)

modifiedDate

<!ELEMENT modifiedDate (#PCDATA)>

This optional element is the date the content was last modified.

Must be one of the following formats:

d/m/yy (example 5/23/01)

d/m/yyyy (example 5/23/2001)

d MM yyyy (example 23 May 2001)

needsPreview

<!ELEMENT needsPreview EMPTY>

This optional element determines whether the submitted content should be held in a Content Management Application (CMA) for preview before being published. All documents by default will go through the regular publishing process. If the tag <needsPreview/> exists in the XML the content will be held in the CMA until it is manually previewed and approved.

Note that this tag cannot contain any values. It is either an empty tag or non-existent.

objectID

<!ELEMENT objectID (#PCDATA)>

objectID is used to uniquely identify a piece of content. It must be a unique identifier within the sourceDatabase entry. The objectID is used to determine when to replace or delete content and when to add content. If multiple items must be grouped, use the relationship elements.

priceInformation

<!ELEMENT priceInformation (productNumber, productPrice, availableAtStore)>

This optional element is used to submit information about product availability and pricing at the business store.

productNumber

<!ELEMENT productNumber (#PCDATA)>

This element is the product number for which the price and availability information is relevent.

productPrice

<!ELEMENT productprice (#PCDATA)>

This is the current price of the product at the business store.

publishDate

<!ELEMENT publishDate (#PCDATA)>

This optional element is the date after which the content is valid. If this item is not used then the content will be published at the next publishing cycle. (every 12 hours) This can be used to submit content that needs to wait several days before it becomes available on the site.

Must be one of the following formats:

d/m/yy (example 5/23/01)

d/m/yyyy (example 5/23/2001)

d MM yyyy (example 23 May 2001)

publishImmediately

<!ELEMENT publishImmediately EMPTY>

This optional element should only be inserted into the XML if the content is required to be published immediately. This tag does not mean that the content will become live immediately! This is only a tag to mark a piece of content for immediate processing should a content publisher be capable of handling that capability.

Note that this tag cannot contain any values. It is either an empty tag or non-existent.

ranking

<!ELEMENT ranking (#PCDATA)>

This element is used to order items that are in the same group. The value can be any positive integer.

region

<!ELEMENT region (#PCDATA)>

This is the name of the region where the content is valid. Multiple region tags can be included within a regions tag.

regions

<!ELEMENT regions (region+)>

The optional element is a container for multiple region values. This should only be used in the case that the content does not have exact country values.

relation

<!ELEMENT relation (relationType, relationName, cascade?)>

If the relationships tag is used this is a required subtype. There can be multiple “relation” items within a relationships tag. Each relation identifies a single relationship between the content and an item within one of the submitted hierarchies.

relationName

<!ELEMENT relationName (#PCDATA)>

This element is the name of the item within a hierarchy (which one is defined by the relationType element below) to which the content is related.

relationships

<!ELEMENT relationships (relation+|priceInformation+)>

This is a container of “relation” items to create relationships between content and items within hierarchies.

relationType

<!ELEMENT relationType (#PCDATA)>

sourceDatabase

<!ELEMENT sourceDatabase (#PCDATA)>

This require element is the name of the database where the content is managed. This is used to help create a unique key with the ObjectID and to help locate the source of the content should there be an error that needs to be corrected. In the cases where the content is manually updated, this value can be “manual.”

summary

<!ELEMENT summary (#PCDATA)>

This optional element is used to give a description of the content. In many cases this will be the actual content submitted.

title

<!ELEMENT title (#PCDATA)>

This optional element is the title of the content submitted.

url

<!ELEMENT url (#PCDATA)>

This optional element is an url. If the url is submitted as part of the item content the link will appear under the “title” element. If the url is submitted as part of the branch content it will appear under the “branchName” element.

The url should be the fully qualified url. That is, it should include the “http://” or “ftp://” as appropriate.

To link to an internal document use the following “CONTENT://sourceDatabase-objectID” in the url and it will be replaced with the appropriate document reference. For example:

<A HREF=“CONTENT://SourceDB-bpm35008”>Go to this support Doc</A>

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

[image]

[image]

1. A computerized content management system comprising:
a receiving queue for receiving content;
a content staging unit, coupled to the receiving queue, and including an operating system to (i) validate the content for format consistency and verify its accuracy and (ii) process the content from a first format to a second format defined by the content management system;
a content storage unit, coupled to the content staging unit, and including an operating system to receive the validated and verified content for use by an application utilized within a computerized content management system.

2. The invention according to claim 1 wherein the content staging unit, while validating the content, further checks for description file information and provides such description file information, if missing.

3. The invention according to claim 2 wherein the content staging unit provides identity of the of the description file after checking.

4. The invention according to claim 1 wherein the content includes a content item having a search hierarchy and the staging unit cleanses the content item to ensure the content item and its search hierarchy are reliably linked.

5. The invention according to claim 4 wherein the content staging unit determines the search hierarchy of the content item and assigns the content item to the identified hierarchy.

6. The invention according to claim 1 wherein the content staging unit checks whether meta-data associated with the content is consistent with a previously defined format for the system.

7. The invention according to claim 1 further comprising a content error zone, coupled to the content staging unit, to receive any content item failing validation.

8. The invention according to claim 1 wherein the content staging unit notifies the content provider if the content failed validation.

9. The invention according to claim 1 wherein the content staging unit maintains a prior valid version of the content for access by the user should the content fail validation.

10. A method of controlling content accessed by an end user within a shared content environment, the method comprising:
receiving at least one content item from a content provider;
checking for description file information;
backfilling information within the description file if missing;
determining if the content item is valid;
copying the content item with an associated description file within an archive;
importing the description file to a content holding database; and
sending valid content to a holding zone.

11. A method of providing error control of content accessed by an end user within a shared content environment, the method comprising:
receiving at least one content item from a content provider with the intent of making available the content item to an end user;
validating the content item is error-free;
making the valid content item available to the content provider for access to the end-user.

12. The method according to claim 11 wherein the validating step comprises cleansing the content item to ensure the content item and its search hierarchy are reliably linked.

13. The method according to claim 11 wherein the validating step comprises archiving the content item.

14. The method according to claim 11 wherein the validating step comprises:
determining the hierarchy of the content item; and
assigning the content item to the identified hierarchy.

15. The method according to claim 11 wherein the validating step comprises checking meta-data associated with the content item is consistent with a previously defined format for the system.

16. The method according to claim 11 further comprising moving the content item to an error zone upon lack of validation.

17. The method according to claim 11 further comprising notifying the content provider that the content item failed validation.

18. The method according to claim 11 further comprising maintaining a prior valid version of the content item for access by the user should the content item fail validation.
